(19) United States
(12) Patent Application Publication
(10) Pub. No.: US 2014/0032448 A1
(43) Pub. Date: Jan. 30, 2014

(54) METHOD, COMPUTER PROGRAMS AND A USE FOR THE PREDICTION OF THE SOCIOECONOMIC LEVEL OF A REGION

(71) Applicants: Enrique Frías MARTÍNEZ, Madrid (ES); Vanessa Frías MARTÍNEZ, Madrid (ES)

(72) Inventors: Enrique Frías MARTÍNEZ, Madrid (ES); Vanessa Frías MARTÍNEZ, Madrid (ES)

(73) Assignee: TELEFONICA, S.A., Madrid (ES)

(21) Appl. No.: 13/556,728

(22) Filed: Jul. 24, 2012

(51) Int. Cl. G06F 15/18

(52) U.S. Cl. 706/12

(57) ABSTRACT

The method includes a computing mechanism running in a computer device receiving as inputs, the geographical region R, base stations giving coverage to the geographical region R and call records generated by individuals using the base stations. Prediction of the socioeconomic level is automatically performed by using information during a given time period from the call records. The computer programs include code adapted for computing the average socioeconomic value for each coverage region and computing a set of variables when the program is run on a computer.

### FIELD OF THE ART

The present invention generally relates, in a first aspect, to a method for the prediction of the socioeconomic level of a region, and more particularly to a method to automatically predict the Socioeconomic Level (SEL) of a region from the calling patterns of the citizens that live within that region.

A second aspect of the present invention relates to computer programs comprising computer program code means adapted for computing the average socioeconomic value for each coverage region and to compute a set of variables when the program is run on a computer.

A third aspect of the present invention relates to a use of information from a plurality of call records during a given time period to automatically perform a prediction of the socioeconomic level of a geographical region R by measuring a number of interactions received by each one of a plurality of base stations giving coverage to said geographical region R during said given time period.

The socioeconomic level (SEL) is an indicator used in the social sciences to characterize regional economic and social status relative to the rest of the society. It is typically defined as a combination of income related variables, such as salary, wealth and/or education.

By base station in the current description, it has to be understood a base station providing communications under any standards, sometimes referred to as BTS. The term encompasses a radio base station, or the so-called node B or eNB and other development standards. The base station is preferably part of a cellular tower, but other embodiments are also possible.

Call records are sometimes referred to Call Detail Records (CDRs).

### PRIOR STATE OF THE ART

The relevance of the SEL factor to explain human behaviors and social conditions can be widely found in the literature in areas like access to health services, public transportation or cancer prevalence. As such, the socioeconomic status of an individual or a household is also an indication of the purchasing power and the tendency to acquire new goods. The information provided by this variable is very relevant from a commercial perspective, as adapting the interaction between a company and a potential client considering the purchasing power of the client is a key element for the success of the interaction.

Due to its ubiquity, cell phones are arising as one of the main sensors of human behavior and as such, they capture a variety of information regarding mobility, social networks and calling patterns that might be correlated to socioeconomic levels. In the literature, it can be found general reports highlighting these relations. For example, prior state of the art studies use cell phone records to study the impact of socioeconomic levels in human mobility. The first step to build tools to predict the socioeconomic level of a person or a region is to analyze the relationship between socio-economic factors and cell phone usage. For instance, a prior study done presented a survey of $277$ microentrepreneurs and mobile phone users in Kigali and Rwanda to understand the types of relationships with family, friends and clients, and its evolution over time. Among other findings, the author discovered that users with higher educational levels were more prone to add new contacts to their social networks. Similar qualitative studies were carried out by conducting surveys to understand the impact of demographics and socio-economic factors on the technology acceptance of mobile phones and found-out that older subscribers felt more pressure to accept the use of mobile phones than their younger counterpart. The method that it is proposed in this patent offers the ability to automatically compute such relationships without the need of interviews or surveys by obtaining the information from the analysis of Call Detail Records (CDRs). By doing so, the present invention also has the ability to expand the analyses to millions of users instead of such a few interviewed individuals.

The literature covering large-scale quantitative analyses of the relationship between cell phone usage and human factors is very limited given the recent availability of large datasets with cell phone call records. One prior research studied the correlation between communication diversity and its index of deprivation in the UK. The communication diversity was derived from the number of different contacts that users of a UK cell phone network had with other users. Eagle combined two datasets: (i) a behavioral dataset with over $250 million cell phone users whose geographical location within a region in the UK was known, and (ii) a dataset with socio-economic metrics for each region in the UK as compiled by the UK Civil Service. The author found that regions with higher communication diversity were correlated with lower deprivation indexes. The method presented elaborates a more fine-grained impact analyses that can draw correlations between human factors and cell phone usage at even smaller scales like cities, neighborhoods or blocks. Additionally, the method proposed in this patent goes beyond correlations and describes an analytical tool that predicts socio-economic levels from cell phone calls.

Another prior art study analyzed the impact that factors like gender or socio-economic status have on cell phone use in Rwanda. Similarly to Eagle, the authors combined two datasets, one containing call detail records from a Telco company in Rwanda and the other one containing socio-economic variables computed from personal interviews with the company's subscribers. Their main findings revealed modest gender-based differences in the use of cell phones and large statistically significant differences across socio-economic levels with higher levels showing larger social networks and larger number of calls among other factors. This approach succeeds to reveal findings at an individual level; however, it limits the scalability of the results to the availability of the subscribers and to the amount of time and money available to carry out personal phone interviews to hundreds of users. To overcome these problems, the method combines two large-scale datasets to understand the relationship between cell phone use and specific socio-economic factors; and formalizes that relationship through a predictive model to be able to approximate the citizens' socio-economic levels from call records.

### PROBLEMS WITH EXISTING SOLUTIONS

There exist various problems with the solutions previously presented that the method successfully overcomes. First of all, the amount of subscribers that can be reached through interviews or questionnaires, this is limited by the capability to reach customers and their availability to collaborate. The method overcomes this issue by computing usage information from CDRs and not through interviews. Another important problem with previous approaches is the subjectivity of the information provided, which depending on the information being collected might be very biased. For example, asking someone about how often they call to specific numbers should be best measured checking the CDRs instead of asking the subscriber himself. A third limitation of previous approaches is the granularity of the region whose socioeconomic level can be predicted. In fact, previous work has shown predictive power when dividing countries into a few regions (for example, one previous work divided the UK into six regions only). On the contrary, it is showed that the method works well for very small regions down to a size of a few square kilometers (blocks in a city).

### DESCRIPTION OF THE INVENTION

It is necessary to offer an alternative to the state of the art which covers the gaps found therein, particularly related to the lack of proposals which really allows the prediction of the socioeconomic level of a region of the individuals that live within that region in a non-invasive way.

To that end, the present invention provides, a method for the prediction of the socioeconomic level of a region, comprising computing means running in a computer device receiving as inputs, a geographical region R, a plurality of base stations giving coverage to said geographical region R and a plurality of call records generated by individuals using said plurality of base stations.

On contrary to the known proposals, the method for doing said prediction of the socioeconomic level is automatically performed by using information during a given time period from said plurality of call records.

The method comprises computing the average usage statistics of cell phone usage for each one of the individuals living within the coverage region of each one of said plurality of base stations and using a plurality of census maps comprising a plurality of socioeconomic values representing the average socioeconomic level of each one of the individuals within a geographical unit.

In a preferred embodiment, the set of variables computed for each one of said plurality of base stations are: behavioral variables, social variables and/or mobility variables.

In another preferred embodiment, the plurality of socioeconomic values are collected by local National Statistical Institutes.

The method of the invention also comprises computing an average socioeconomic value for each coverage region, said average socioeconomic value being computed as a weighted average of the regions that cover the coverage area of each one of said plurality of base stations and the steps of:

associating said average usage statistics of cell phone usage of each one of said plurality of base stations with the corresponding average socioeconomic value of each coverage region;

building a list that is used as a training set;

using said training set for testing a plurality of different machine learning techniques; and

selecting a machine learning techniques from said plurality of different machine learning techniques for generating and giving the best prediction.

Finally, in another preferred embodiment, the method uses the socioeconomic level of a region predicted for marketing purposes.

Other embodiments of the method of the invention are described according to appended claims, and in a subsequent section related to the detailed description of several embodiments.

A second aspect of the present invention relates to a computer program comprising computer program code means adapted to perform all the steps of claims 7 for computing the average socioeconomic value for each coverage region when the program is run on a computer, and a computer program comprising computer program code means adapted to compute the set of variables of claim 2 when the program is run on a computer.

A third aspect of the present invention relates to a use of information from a plurality of call records during a given time period to automatically perform a prediction of the socioeconomic level of a geographical region R by measuring a number of interactions received by each one of a plurality of base stations giving coverage to said geographical region R during said given time period.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the flow diagram of the calibration phase of Step 1, according to an embodiment of the present invention.

FIG. 2 shows the calibration phase of Step 2, according to an embodiment of the present invention. Where (2a) is a map of SELs from NSI, (2b) a map of BTSs from Telco, (2c) the compute overlapping areas and (2d) is the flow diagram of Step 2.

FIG. 3 shows the flow diagram of the calibration phase of Step 3, according to an embodiment of the present invention.

FIG. 4 shows the flow diagram from the calling patterns for each specific region in order to determine the optimal prediction algorithm to predict the SEL, according to an embodiment of the present invention.

FIG. 5 shows the flow diagram of the prediction phase, according to an embodiment of the present invention.

FIG. 6 shows the results of the method after running the Calibration and the Prediction phase on an urban region.

### DETAILED DESCRIPTION OF SEVERAL EMBODIMENTS

The present invention proposes a method to predict the socioeconomic level (SEL) of a region from the Call Detail Records (CDRs) of the subscribers that live within that region. The approach enhances previous solutions by eliminating the need to carry out surveys or questionnaires as well as by improving the granularity of the prediction algorithms with regions down to a few square kilometers.

The method makes use of the information extracted from cellular networks. Specifically, it is assumed that a geographical area is divided into different regions BTS1, BTS2 . . . BTSn each one associated to a cellular tower or BTS that gives coverage to a region. For simplicity purposes, it is assumed that each coverage region is represented by a non-overlapping Voronoi polygon. Thus, a city can be represented by a set of polygons each one associated to a cellular tower BTSi. In order to characterize cell phone usage for that region, a set of variables for each BTS that represents average usage statistics is computed for the citizens that live within that region.

The method in this patent also makes use of census maps collected by local National Statistical Institutes (NSIs). NSIs carry out interviews every 5 to 10 years to compute the SEL values of different regions within a country. Such interviews are done household by household after selecting a representative set of families. The interviews gather information related to the education level, salaries and health access. The NSIs divide cities into different geographical units (GUs) and assign to each unit an average value representing the average socioeconomic level for the citizens that live within that region.

The method uses the CDRs and the NSI's datasets to build a model such that given any set of CDRs at any point in time, the distribution of SELs for that region can be predicted. The method associates to each BTS a model of average cell phone usage for all the citizens that live within the coverage region of each BTS. Next, it computes a SEL value for each coverage area by obtaining a weighted average of the GUs that covers the BTS area. Finally, it computes a prediction model that optimizes the prediction rate of the SELs of the regions from the CDRs. It can be noted that the census maps are uniquely used for the training of the system. Once the system is trained only CDRs are necessary to predict the SEL of a specific region.

Although in principle the method could work in both rural and urban areas, it works better in urban areas since the distribution of coverage areas is more uniform and thus higher granularities can be achieved.

The method consists of two steps: (1) Calibration Phase and (2) Prediction Phase. The Calibration Phase is run only once for the bootstrap of the system. This phase uses as input the CDRs of the region under study and the distribution of SELs computed by the NSI for that region. With these datasets, it computes—for each BTS coverage area—all the variables that measure the calling patterns of the subscribers that live within that area; next, it associates to each BTS a SEL value computed from the overlapping of BTS coverage areas and GUs. Once these associations are computed, the training set is ready for the calibration phase to obtain a prediction model that optimizes the prediction rate of the SELs from the CDRs. This step is executed only once unless a different geographical area (city) is studied.

1. The Calibration Phase.

It receives as input the CDRs of the citizens that live within the geographical area under study as well as the distribution of SEL values for that same area and follows three steps:

Step 1: For the area of coverage of each BTS (1a), compute the average calling patterns for the citizens that live within that region (1b). This process is repeated for all the BTSs that lie within the geographical area under study. Such patterns represent an average behavior for all the citizens that live within the geographical area covered by the BTS.

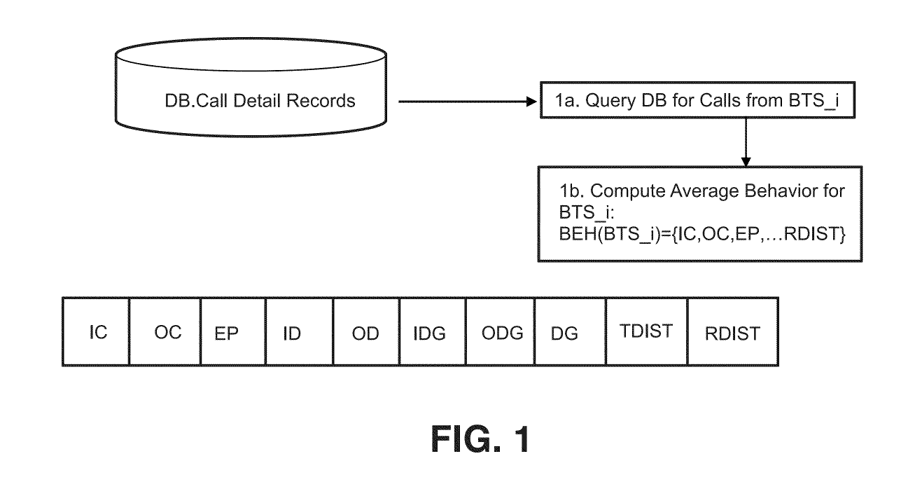

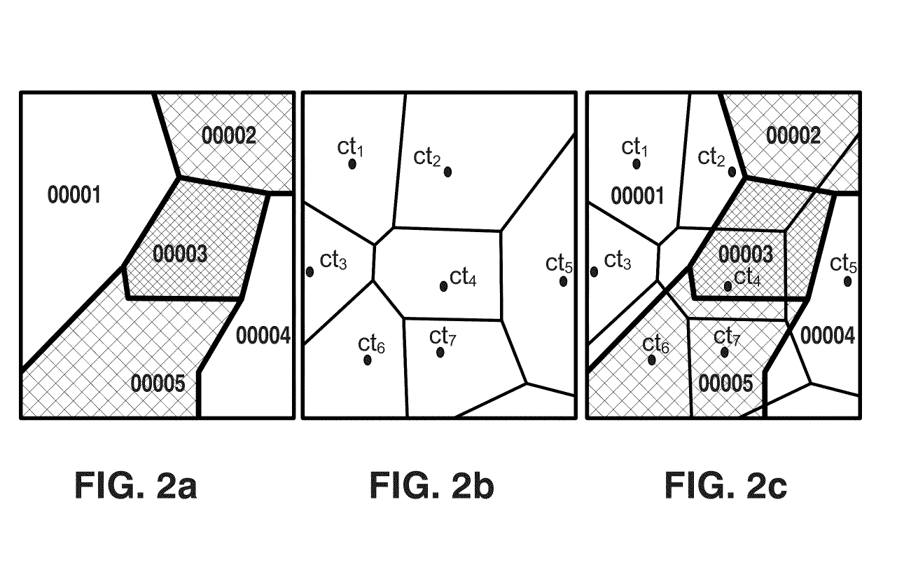

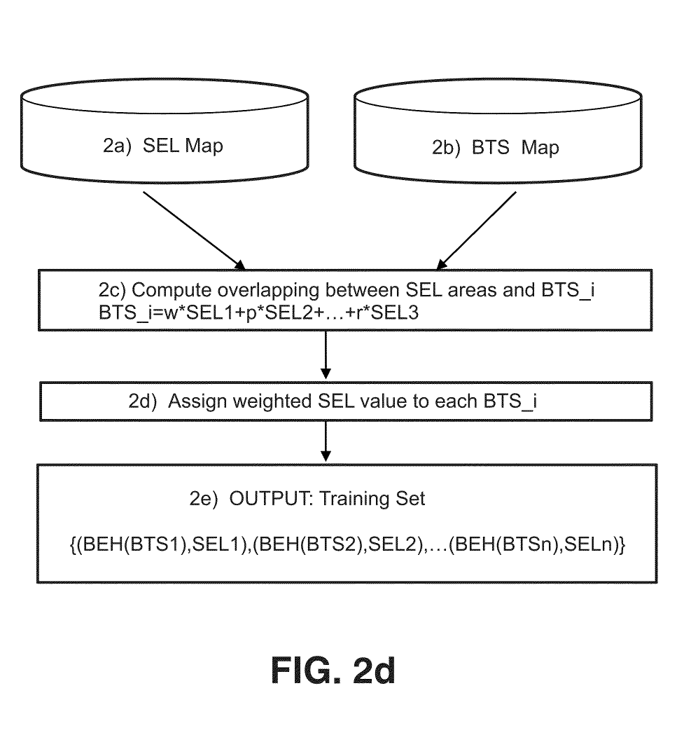

Specifically, it is computed the following set of variables for each subscriber whose residential location is under the same BTSi and then average across all the subscribers BEH (BTSi). These variables are computed using the information saved in the Call Detail Records database as shown in FIG. 1.
Behavioral Variables: it is measured the number of input and output calls (IC, OC), duration of the calls (both input and output) and the expenses throughout D months.

$${IC}_{j} = {\sum }_{i = 0}^{D} incalls ( {day}_{i} , j )$$

$${OC}_{j} = {\sum }_{i = 0}^{D} outcalls ( {day}_{i} , j )$$

$${IDUR}_{j} = \frac{{\sum }_{i = 0}^{{IC}_{j}} duration ( {incall}_{i} , j )}{{IC}_{j}}$$

$${ODUR}_{j} = \frac{{\sum }_{i = 0}^{{OC}_{j}} duration ( {outcall}_{i} , j )}{{OC}_{j}}$$

$${EP}_{j} = \frac{{\sum }_{i = 0}^{D} expense ( {day}_{i} , j )}{{IC}_{j} + {OC}_{j}} .$$

Social Variables: it is measured their in-degree (IDG) or number of different cell phones that called subscriber j, their out-degree (ODG) or number of different cell phones subscriber j called to, and the degree (DG) defined as the cell phone numbers that were both present in IDG and ODG.

IDGⱼ=|∪ᵢ₌₀^{IC}^{ⱼ}Nᵢ| ODGⱼ=|∪ᵢ₌₀^{OC}^{ⱼ}Nᵢ|

DGⱼ=|(IDGⱼ∪ODGⱼ)|−|(IDGⱼ∩ODGⱼ)|
Mobility Variables: it is measured the distances that the subscriber travels while (s)he talks (Talk Distance TDIST) or between calls (Route Distance RDIST). Every time a call is placed or received, the CDR generated contains the latitude and longitude of the BTS where the call started and ended. From these data, it can be computed the distance that the subscriber j travelled during each call (TDIST) or the distance the subscriber travels between calls (RDIST).

$${TDIST}_{j} = \frac{{\sum }_{i = 0}^{{IC}_{j} + {OC}_{j}} d ( {t}_{0} ( i ) , {t}_{f} ( i ) )}{{IC}_{j} + {OC}_{j}}$$

$${RDIST}_{j} = \frac{{\sum }_{i = 0}^{{IC}_{j} + {OC}_{j}} d ( {t}_{f} ( i - 1 ) , {t}_{0} ( i ) )}{{IC}_{j} + {OC}_{j}}$$

Step 2: Given that the SEL values computed by the NSI do not necessarily correspond to the areas of coverage of each BTS, it needs to be associated to each coverage area a SEL value computed as a weighted average of the values of the regions that cover the coverage area of a BTS.

This step first draws a numerical representation of the SEL map (2a), next of the cellular tower map (2b) and next, it computes the overlapping between the two such that each BTS coverage area is represented as a weighted average of the SEL areas that cover it (2c). Using (2c) it can be computed an average SEL value for each BTS in the geographical area under study using a formula like:

BTS_{—}i=w*SEL1+p*SEL2+ . . . r*SEL3

At the end of this process, the invention has a list that contains pairs of BTS and SEL value associated to that BTS. The method associates the average calling patterns for each BTS to its SEL value and build a list that is used as the training set for the prediction algorithm: {BEH(BTS1), BEH(BTS2), . . . BEH(BTSn)}.

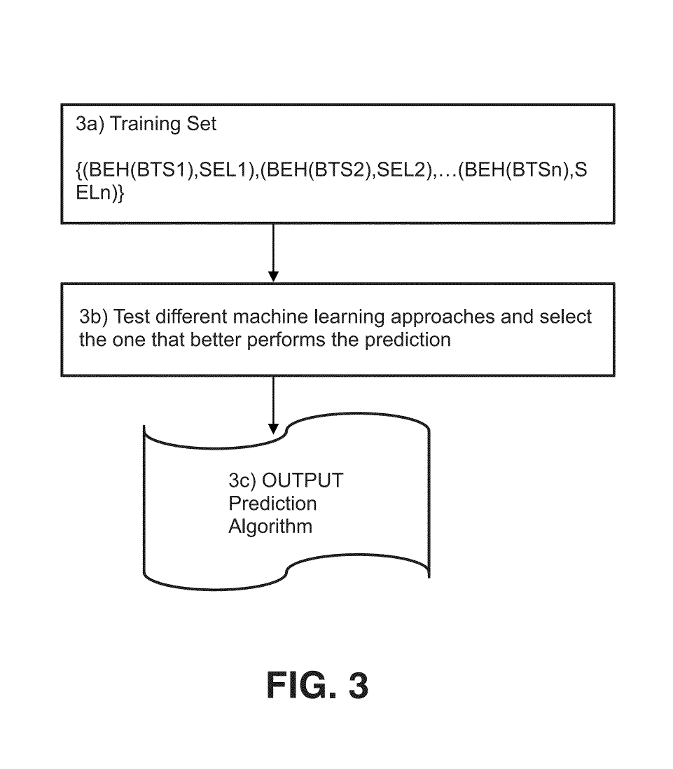

Step 3: The output from Step 2 is used by this step as input (3a), see FIG. 3, to test different machine learning techniques (3b). Once the best predictive technique is detected, it is output by the system (3c) to be used during the Prediction Phase (2).

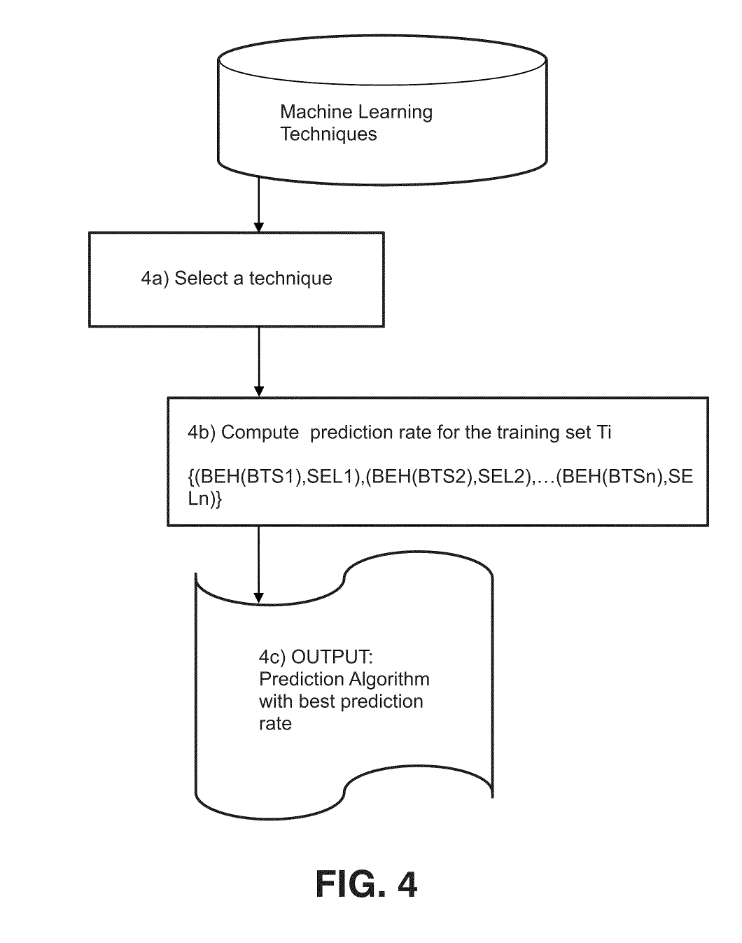

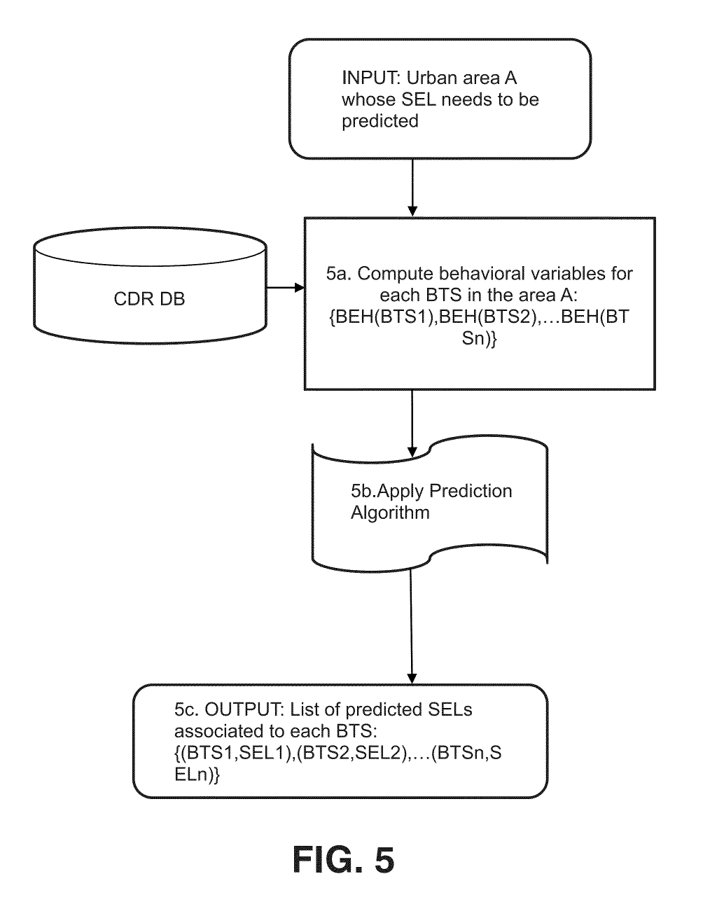

In order to determine the optimal prediction algorithm to predict the SEL from the calling patterns for each specific region, FIG. 4 shows the necessary steps. First, a machine learning technique from a database with different techniques is selected. Second, the training set from Step 2 (4a) is fetched and tested the machine learning technique on that set (4b). Once the process is executed for all techniques in the DB, it is selected the one that generates the best predictor in terms of prediction rate and give it as output (4c).

2. The Prediction Phase.

The Prediction Phase can be run as many times as necessary to predict the SELs of a geographic area. Specifically, every time researchers need to know the socioeconomic level of a specific city/region, they give as input the area A whose SEL levels want to be predicted. Next, the method retrieves from the CDR DB the call records of the subscribers that live within the region of interest A. It then computes (5a) the average behavioral, consumption and mobility variables for each BTS_i within the region, as specified in Step 1 of the Calibration Phase. Finally, the method applies the machine learning technique (5b) selected during the Calibration Phase to the set of {BEH(BTS_i)} and outputs the SELs predicted for each BTS (5c).

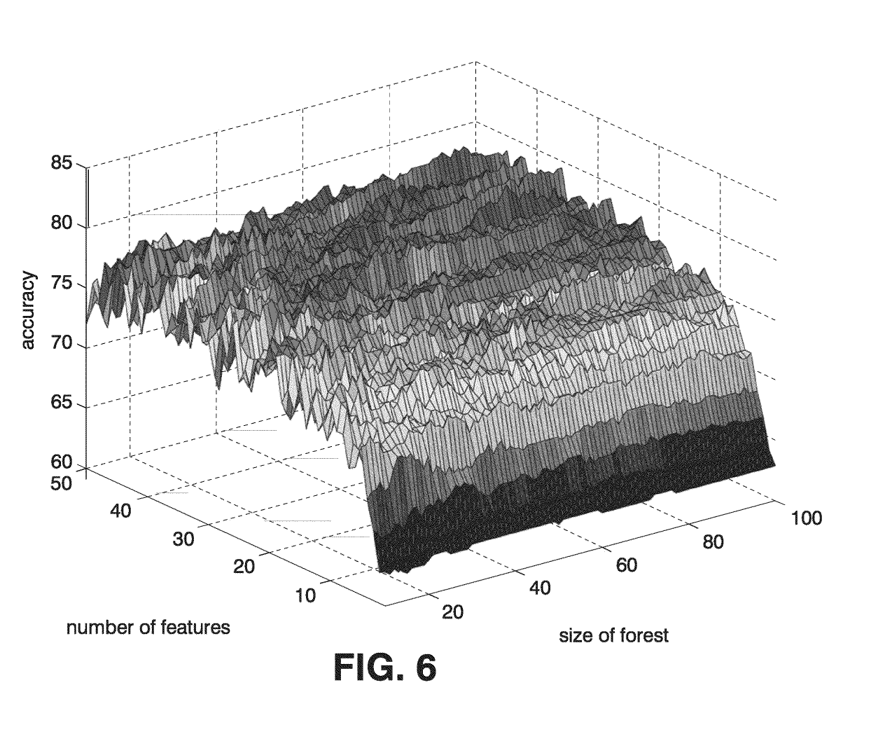

FIG. 6 shows the results of the proposed invention after running the Calibration and the Prediction phase on an urban region. The method reaches correct classification rates of up to 80.7% when using the best technique selected by the method presented (Random Forests).

### ADVANTAGES OF THE INVENTION

The method here presented has two important advantages:
Allows marketing units to predict the SELs of an urban region without the need to buy the expensive census datasets that are sold by local NSIs. Additionally, it allows approximating the SEL values at any point in time and not just every 5 or 10 years like the NSIs do.
Enhances previous methodologies by allowing prediction at higher granularities. Specifically, the smallest granularity at which a SEL can be predicted is a few square kilometers. Such granularity is always dependent on the size of the Voronoi polygons that approximate the coverage area. For that reason it is recommended to execute the method in urban regions, although in principle it should also work in rural environments.

### POTENTIAL USES OF THE INVENTION

Marketing units that want to personalize offers to subscribers according to their socioeconomic level. Until now, marketers used the maps provided by the NSIs which are updated only every 5/10 years. The method allows marketing units to have updated maps as frequently as necessary.

Governments that want to save money when computing census maps. Telecommunication companies that have access to databases of CDRs could offer governments the possibility of computing approximate census maps with the SELs of regions without the need to carry out the expensive interviews and questionnaires that they currently deploy to gather such data.

### ACRONYMS

SEL Socioeconomic level
NSI National Statistical Institute
CDR Call Detail Record
DB Database

1. A method for the prediction of the socioeconomic level of a region, comprising computing means running in a computer device receiving as inputs, the geographical region R, a plurality of base stations giving coverage to said geographical region R and a plurality of call records generated by individuals using said plurality of base stations, wherein said prediction of the socioeconomic level is performed automatically by using information during a given time period from said plurality of call records.

2. A method according to claim 1, comprising computing for each one of said plurality of base stations a set of variables in order to represent an average usage statistics of cell phone usage for each one of the individuals living within the coverage region of each one of said plurality of base stations.

3. A method according to claim 2, wherein said set of variables computed for each one of said plurality of base stations are: behavioral variables, social variables and/or mobility variables.

4. A method according to claim 2, comprising using a plurality of census maps comprising a plurality of socioeconomic values representing the average socioeconomic level of each one of the individuals within a geographical unit.

5. A method according to claim 4, wherein said plurality of socioeconomic values are collected by local National Statistical Institutes.

6. A method according to claim 4, further comprising computing an average socioeconomic value for each coverage region, said average socioeconomic value being computed as a weighted average of the regions that cover the coverage area of each one of said plurality of base stations.

7. A method according to claim 6, comprising the steps of:
associating said average usage statistics of cell phone usage of each one of said plurality of base stations with the corresponding average socioeconomic value of each coverage region;
building a list that is used as a training set;
using said training set for testing a plurality of different machine learning techniques; and
selecting a machine learning techniques from said plurality of different machine learning techniques for generating and giving the best prediction.

8. A method according to claim 1, wherein each coverage region of each one of said plurality of base stations is represented by a non-overlapping Voronoi polygon.

9. A method according to claim 3, wherein said behavioral variables are: a number of input and output calls (IC, OC), a duration of the calls or expenses throughout the months.

10. A method according to claim 3, wherein said social variables are: a number of different phone calls an individual received or IDG, a number of different phone calls said individual made or ODG or said phone call where both said IDG and said ODG where present.

11. A method according to claim 3, wherein said mobility variables are: a talk distance (TDIST) measured while said individual talks or a route distance (RDIST) measured between calls.

12. A computer program comprising computer program code means adapted to perform the steps of claim 7 for computing an average socioeconomic value for each coverage region when the program is run on a computer.

13. A computer program comprising computer program code means adapted to compute a set of variables of claim 2 when the program is run on a computer.

14. Use of information from a plurality of call records during a given time period to automatically perform a prediction of the socioeconomic level of a geographical region R by measuring a number of interactions received by each one of a plurality of base stations giving coverage to said geographical region R during said given time period.
